(19) United States
(12) Patent Application Publication
(10) Pub. No.: US 2014/0246456 A1
(43) Pub. Date: Sep. 4, 2014

(54) BEVERAGE SERVER WITH A DRIP TRAY REMOVABLE BY HAND

(71) Applicant: GUANGZHOU HEKOUMEI HOUSEWARE DEVELOPMENT CO. LTD., Guangzhou (CN)

(72) Inventor: Wei Huang, Guangzhou (CN)

(73) Assignee: GUANGZHOU HEKOUMEI HOUSEWARE DEVELOPMENT CO. LTD., Guangzhou (CN)

(21) Appl. No.: 14/050,366

(22) Filed: Oct. 10, 2013

(30) Foreign Application Priority Data
Mar. 1, 2013 (CN) 201320093169.7

(51) Int. Cl. B67D 1/16

(52) U.S. Cl. CPC A47J 31/4428
USPC 222/108

(57) ABSTRACT

A beverage server with a drip tray removable by hand comprising a barrel body, a supporting base disposed at a bottom part of the barrel body, a water outlet provided at a side portion of the barrel body, and a drip tray provided exactly below the water outlet; the drip tray and the supporting base are removably connected with each other. The present invention has a simple structure and a lower manufacturing cost, it does not require an additional tray, instead, the drip tray can be directly pulled out horizontally and so water inside the drip tray will not easily spill out; also, the drip tray is not easy to get lost and can be removed conveniently.

### BACKGROUND OF THE INVENTION

The present invention relates to a beverage server with a drip tray removable by hand.

Nowadays, a beverage server generally comprises a barrel body and a supporting base disposed at the bottom of the barrel body. A side portion of the barrel body is provided with a water outlet. A drip tray is provided below the water outlet. The drip tray and the supporting base are either inseparable or separable; if they are inseparable, they will bring much inconvenience to users when users pour water from the barrel; if they are separable and unrestricted by any connection, the drip tray will be lost easily and may be easily displaced away from where the water comes out.

Some improvements have been made to solve the above problems. In essence, an independent tray disposed with a recess is formed at a bottom part of the supporting base; the tray and the bottom part of the supporting base are formed in one piece. The recess has a shape that matches with the drip tray. The drip tray is directly disposed in the recess of the tray. This structure can somehow solve the problems as mentioned above but it still has the following disadvantages: 1. The tray is required as an additional component, resulting in harder manufacturing technique, higher manufacturing cost and more complicated structure; 2. Since the drip tray is disposed in the recess of the tray, the drip tray has to be lifted up so that its bottom is above the recess before it can be taken out, and this way of taking out the drip tray is very inconvenient especially when the drip tray contains water because users' hands may tremble easily when lifting up the drip tray containing water; as a result, the water in the drip tray may spill out easily; 3. Since the drip tray is simply disposed in the recess of the tray without any connection, the drip tray may easily fall out of the recess when moving the beverage server and thus causing more trouble during use of the beverage server; also there exists the risk of losing the drip tray.

### BRIEF SUMMARY OF THE INVENTION

In view of the aforesaid disadvantages now present in the prior art, the present invention provides a beverage server with a drip tray removable by hand; wherein the beverage server with a drip tray removable by hand has a simple structure and a lower manufacturing cost.

Another object of the present invention is to provide a beverage server with a drip tray removable by hand according to which an additional tray is not required, a drip tray can be directly taken out by horizontal pulling, and water in the drip tray will not easily spill out.

Yet another object of the present invention is to provide a beverage server with a drip tray removable by hand according to which the drip tray will not be lost easily and can be conveniently removed.

The beverage server with a drip tray removable by hand according to the present invention comprises a barrel body, a supporting base disposed at a bottom part of the barrel body, a water outlet provided at a side portion of the barrel body, and a drip tray provided exactly below the water outlet; the drip tray and the supporting base are removably connected with each other.

The present invention also has the following additional features:

The drip tray is disposed horizontally; the drip tray can be pulled out and pushed in horizontally to accomplish respectively separation and connection between the drip tray and the supporting base.

There are two horizontal gliding rods on the supporting base; the two horizontal gliding rods are disposed with a certain distance away from each other; two horizontal gliding slots corresponding to the two horizontal gliding rods are disposed on the drip tray for receiving insertion of the two horizontal gliding rods.

Convex fitting parts are disposed at ends of the horizontal gliding rods; concave fitting parts which corresponds to the convex fitting parts and which can be fitted with the convex fitting parts are disposed inside the horizontal gliding slots.

Each of the convex fitting parts is a semi-circular protrusion, and each of the concave fitting parts is a semi-circular recess.

The two horizontal gliding rods are parallel to each other and disposed at the same horizontal level.

The two horizontal gliding slots are symmetrically disposed respectively at a left end portion and a right end portion of the drip tray; one of the two horizontal gliding slots has a cross section in a shape resembling a letter “C” (which may be figuratively illustrated as having the shape “[”), and another one of the two horizontal gliding slots has a cross section in a shape resembling an inverted letter “C” (which may be figuratively illustrated as having the shape “]”).

One side of an insertion end of each of the horizontal gliding slots is disposed with a slanted guiding surface.

The drip tray comprises an inwardly recessed water trough and a cover plate with several through holes covering a top part of the water trough; periphery of the water trough has platforms for supporting the cover plate.

Compared with the existing prior art, the beverage server with a drip tray removable by hand according to the present invention has the following advantages: The present invention has a simple structure and a lower manufacturing cost, it does not require an additional tray, instead, the drip tray can be directly pulled out horizontally and so water inside the drip tray will not easily spill out; also, the drip tray is not easy to get lost and can be removed conveniently.

### BRIEF DESCRIPTION OF THE DRAWINGS

The present invention is now described in detail below with reference to an embodiment and the accompanying drawings:

FIG. 1 illustrates an overall structure of the present invention.

FIG. 2 is a perspective view illustrating a condition in which the drip tray and the supporting base of FIG. 1 are separated.

FIG. 3 is an enlarged view of portion A of FIG. 2.

FIG. 4 is an exploded perspective view illustrating a condition in which the drip tray and the supporting base of FIG. 1 are separated.

FIG. 5 is a top view of one of the horizontal gliding slots appearing in FIG. 2.

FIG. 6 is a cross-sectional view of the drip tray as illustrated in FIG. 2.

FIG. 7 is a side view illustrating how a convex fitting part on one of the horizontal gliding rods and a corresponding concave fitting part on one of the horizontal gliding slots as in FIG. 2 fit with each other.

### DETAILED DESCRIPTION OF THE INVENTION

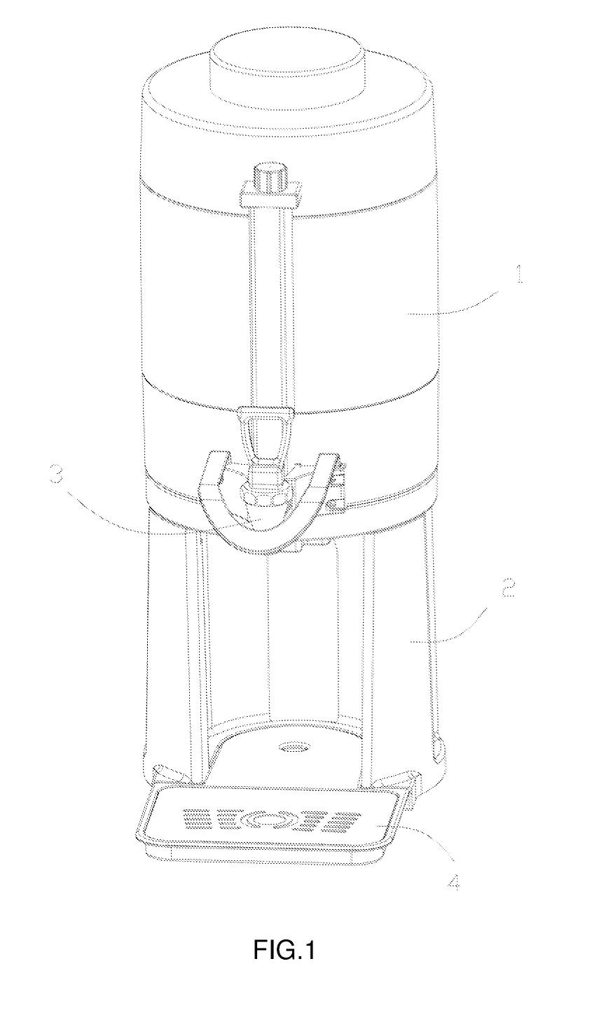

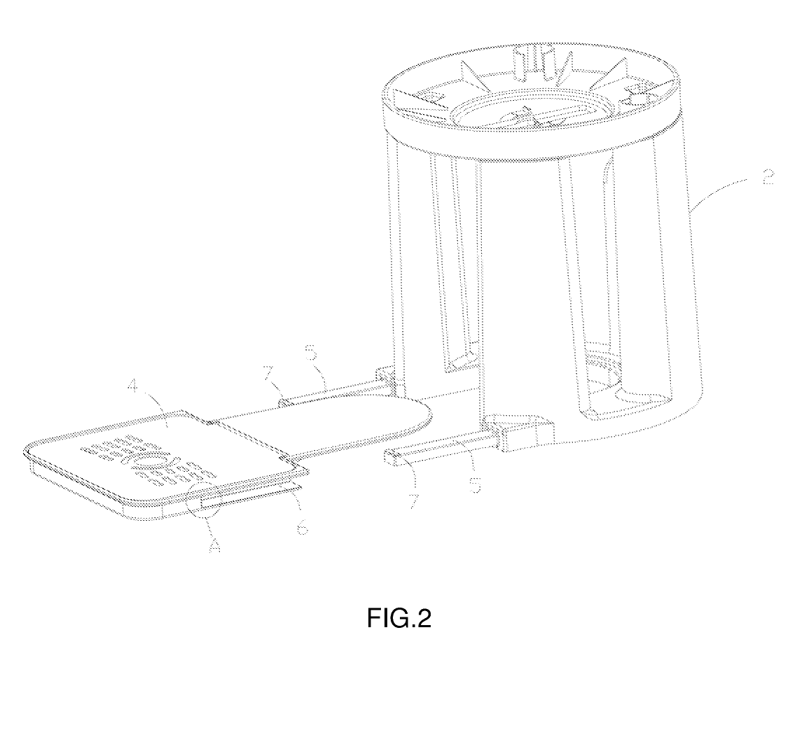

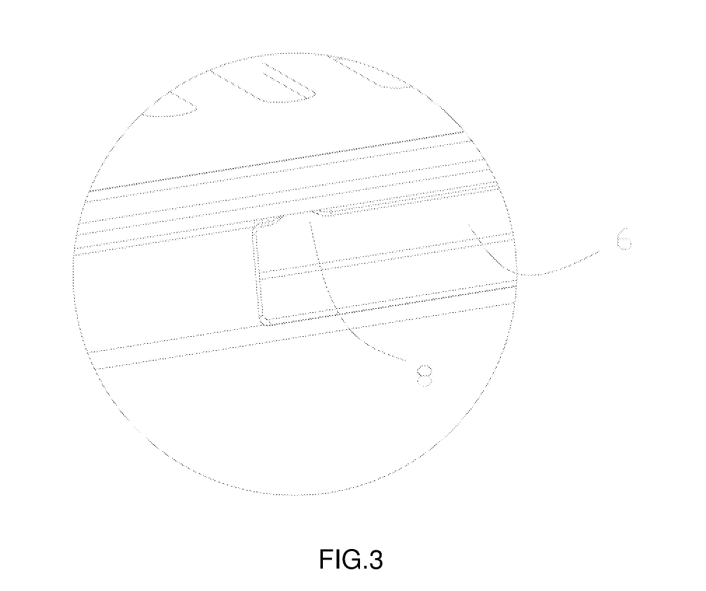

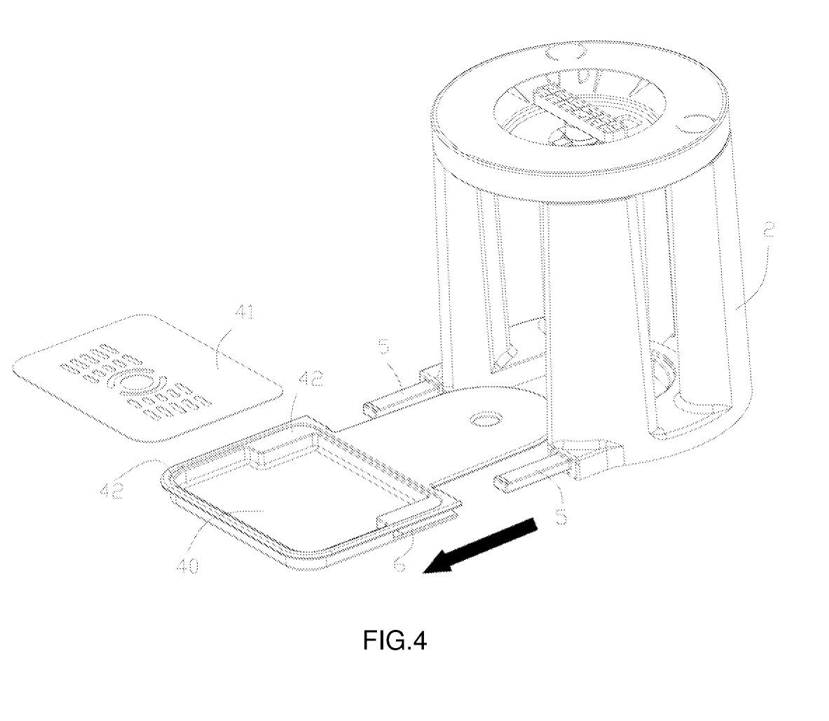

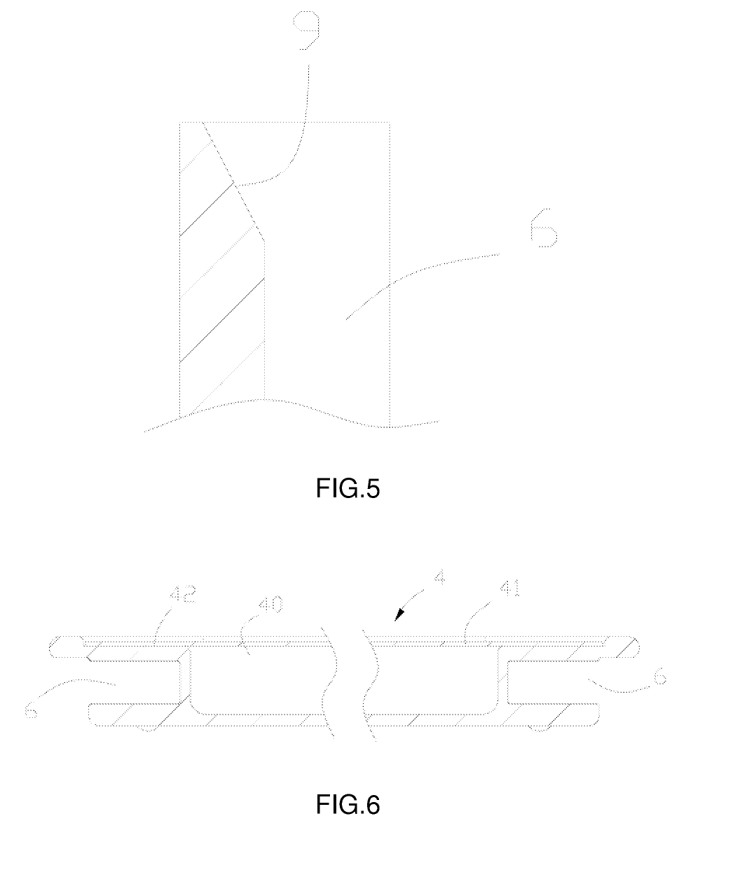

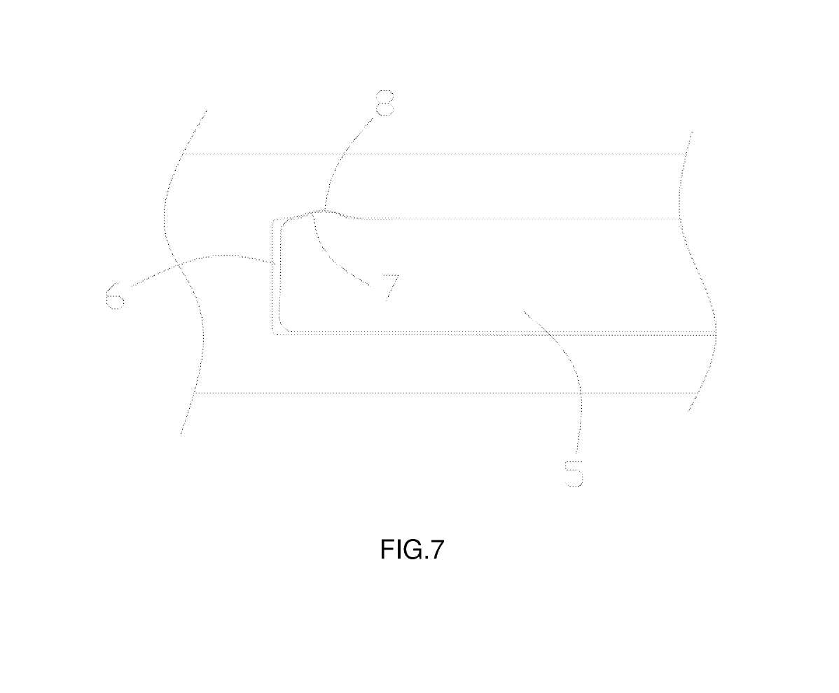

FIGS. 1-7 illustrate a preferred embodiment of the beverage server with a drip tray removable by hand according to the present invention. The beverage server with a drip tray removable by hand comprises a barrel body 1, a supporting base 2 disposed at a bottom part of the barrel body 1, a water outlet 3 provided at a side portion of the barrel body 1, and a drip tray 4 provided exactly below the water outlet 3. The drip tray 4 comprises an inwardly recessed water trough 40 and a cover plate 41 with several through holes covering a top part of the water trough 40. Periphery of the water trough 40 has platforms 42 for supporting the cover plate 41. The drip tray 4 and the supporting base 2 are removably connected with each other so that the drip tray 4 and the supporting base 2 can be separated from each other and can also be assembled and connected with each other. Accordingly, the drip tray 4 can be easily taken out to empty the water inside when necessary, and will not be lost easily when it is receiving water because it can form a one whole piece with the supporting base 2 when it is receiving water.

The drip tray 4 is disposed horizontally. The drip tray 4 can be pulled out and pushed in horizontally according to various different structures to accomplish respectively separation and connection between the drip tray 4 and the supporting base 2. According to the structure being used to pull out and push in the drip tray 4 horizontally in the present embodiment, there are two horizontal gliding rods 5 on the supporting base 2; the two horizontal gliding rods 5 are disposed with a certain distance away from each other; two horizontal gliding slots 6 corresponding to the two horizontal gliding rods 5 are disposed on the drip tray 4 for receiving insertion of the two horizontal gliding rods 5. The drip tray 4 and the supporting base 2 are therefore removably connected with each other by means of the horizontal gliding rods 5 and the horizontal gliding slots 6. This kind of structure as detailed above is very simple and has a lower manufacturing cost. An additional tray is not necessary. Also, since the drip tray 4 can be directly pulled out horizontally, the water inside the drip tray 4 will not spill out easily. In the present embodiment, the two horizontal gliding rods 5 are parallel to each other and disposed at the same horizontal level. However, the two horizontal gliding rods 5 may not be parallel with each other in other embodiments. The two horizontal gliding slots 6 are symmetrically disposed respectively at a left end portion and a right end portion of the drip tray 4. One of the two horizontal gliding slots 6 has a cross section in a shape resembling a letter “C” (which may be figuratively illustrated as having the shape “[”), and another one of the two horizontal gliding slots has a cross section in a shape resembling an inverted letter “C” (which may be figuratively illustrated as having the shape “]”).

In the present embodiment, convex fitting parts 7 are disposed at ends of the horizontal gliding rods 5. Corresponding concave fitting parts 8 which can be fitted with the convex fitting parts 7 are disposed inside the horizontal gliding slots 6. The convex fitting parts 7 and the corresponding concave fitting parts 8 are designed so that they can be locked and can also be unlocked by applying slight forces. In the present embodiment, each of the convex fitting parts 7 is a semi-circular protrusion, and each of the concave fitting parts 8 is a semi-circular recess. Consequently, when moving the beverage server, the drip tray 4 and the supporting base 2 cannot be separated easily. Accordingly, the drip tray 4 will not be lost easily. In other embodiments, other structures apart from the fitting between the convex fitting parts 7 and the corresponding concave fitting parts 8 may be used to restrict separation between the drip tray 4 and the supporting base 2; for instance, the same purpose of restricting separation between the drip tray 4 and the supporting base 2 can be achieved by interference fit between the horizontal gliding slots 6 and the horizontal gliding rods 5 with small amount of interference.

In the present embodiment, one side of an insertion end of each of the horizontal gliding slots 6 is disposed with a slanted guiding surface 9. The slanted guiding surface 9 is provided so that a corresponding horizontal gliding rod of the horizontal gliding rods 5 can be easily inserted.

To mount the drip tray 4, align the two horizontal gliding slots 6 of the drip tray 4 respectively with the two horizontal gliding rods 5 on the supporting base 2, and then push the drip tray 4 towards the supporting base 2 so that the horizontal gliding rods 5 insert into the horizontal gliding slots 6; the drip tray 4 is mounted when the convex fitting parts 7 and the corresponding concave fitting parts 8 are fitted with one another. As illustrated, the mounting procedure is very simple. To remove the drip tray 4, apply slight forces to pull the drip tray 4 horizontally at a direction opposite to the direction of pushing the drip tray 4 when mounting the drip tray 4; the drip tray 4 and the supporting base 2 will then be separated. As illustrated, the removing procedure is very convenient.

The above embodiment is only given to explain the present invention. The above embodiment does not limit the present invention. Any person skilled in this field of art can change and modify the present invention provided that the change and modification do not deviate from the spirit and scope of the present invention. All other equivalent technical proposals should therefore fall within the scope of the present invention. The scope of protection of the present invention is limited by the Claims.

What is claimed is:

1. A beverage server with a drip tray removable by hand comprises a barrel body (1), a supporting base (2) disposed at a bottom part of the barrel body (1), a water outlet (3) provided at a side portion of the barrel body (1), characterized in that, a drip tray (4) is provided exactly below the water outlet (3); the drip tray (4) and the supporting base (2) are removably connected with each other.

2. The beverage server with a drip tray removable by hand as in claim 1, wherein the drip tray (4) is disposed horizontally; the drip tray (4) can be pulled out and pushed in horizontally to accomplish respectively separation and connection between the drip tray (4) and the supporting base (2).

3. The beverage server with a drip tray removable by hand as in claim 1, wherein there are two horizontal gliding rods (5) on the supporting base (2); the two horizontal gliding rods (5) are disposed with a certain distance away from each other; two horizontal gliding slots (6) corresponding to the two horizontal gliding rods (5) are disposed on the drip tray (4) for receiving insertion of the two horizontal gliding rods (5).

4. The beverage server with a drip tray removable by hand as in claim 3, wherein convex fitting parts (7) are disposed at ends of the horizontal gliding rods (5); concave fitting parts (8) which corresponds to the convex fitting parts (7) and which can be fitted with the convex fitting parts (7) are disposed inside the horizontal gliding slots (6).

5. The beverage server with a drip tray removable by hand as in claim 4, wherein each of the convex fitting parts (7) is a semi-circular protrusion, and each of the concave fitting parts (8) is a semi-circular recess.

6. The beverage server with a drip tray removable by hand as in claim 3, wherein the two horizontal gliding rods (5) are parallel to each other and disposed at the same horizontal level.

7. The beverage server with a drip tray removable by hand as in claim 6, wherein the two horizontal gliding slots (6) are symmetrically disposed respectively at a left end portion and a right end portion of the drip tray (4); one of the two horizontal gliding slots (6) has a cross section in a shape resembling a letter “C”, and another one of the two horizontal gliding slots has a cross section in a shape resembling an inverted letter “C”.

8. The beverage server with a drip tray removable by hand as in claim 3, wherein one side of an insertion end of each of the horizontal gliding slots (6) is disposed with a slanted guiding surface (9).

9. The beverage server with a drip tray removable by hand as in claim 1, wherein the drip tray (4) comprises an inwardly recessed water trough (40) and a cover plate (41) with several through holes covering a top part of the water trough (40); periphery of the water trough (40) has platforms (42) for supporting the cover plate (41).
